(19) United States
(12) Patent Application Publication
(10) Pub. No.: US 2026/0336452 A1
(43) Pub. Date: Oct. 29, 2026

(54) Method and System for Determining Triggering of a Charging Contactor

(71) Applicant: Bayerische Motoren Werke Aktiengesellschaft, Muenchen (DE)

(72) Inventor: Andreas Kopp, Hoehenkirchen-Siegertsbrunn (DE)

(21) Appl. No.: 19/649,832

(22) Filed: Apr. 16, 2026

(30) Foreign Application Priority Data
Apr. 23, 2025 (DE) 10 2025 115 706.5

(51) Int. Cl. B60L 53/62; B60L 53/65; B60L 53/66

(52) U.S. Cl. CPC B60L 53/62; B60L 53/65; B60L 53/665; B60L 2240/54; B60L 2240/70

(57) ABSTRACT

A method for determining whether a charging mode setting for a vehicle received by an external control interface triggers an additional switching cycle of a charging contactor comprised in the vehicle, the method including receiving a charging mode setting via the external control interface, providing vehicle-specific charging parameters, detecting a current state of charge of the vehicle with regard to multiple operating modes, simulating a state of charge after execution of the received charging mode setting on the basis of the provided vehicle-specific charging parameters, comparing the current state of charge and the simulated state of charge of the vehicle to determine whether a transition exists between the multiple operating modes which causes a new additional switching cycle of the charging contactor and, only in the case of such a transition, determining the received charging mode setting as an additional switching cycle.

### CROSS-REFERENCE TO RELATED APPLICATION

This application claims priority under 35 U.S.C. §119 from German Patent Application No. 10 2025 115 706.5, filed Apr. 23, 2025, the entire disclosure of which is herein expressly incorporated by reference.

### BACKGROUND AND SUMMARY

The disclosure relates to a method and a system for determining whether a charging mode setting for a vehicle received by an external control interface (API) triggers an additional switching cycle of a charging contactor comprised by the vehicle.

The present disclosure relates to the technical area of charging infrastructure control for electric vehicles, in particular in the interaction between external charging partners and the backend systems of vehicle producers.

In the context of the increasing electrification of the traffic sector, technologies for the remote control of charging procedures via Internet-based interfaces (APIs) are gaining importance. So-called remote charging interfaces have a central role in this case. These are Internet-based programming interfaces which vehicle producers provide to external partners, typically energy service providers, in order to remotely influence charging processes of individual vehicles or entire vehicle fleets. The condition for this is always the consent of the respective vehicle user. In particular, charging procedures can be started, paused, or planned within defined time windows via these interfaces. The goal is to adapt a charging time flexibly to economic and network-technology boundary conditions, for example by deliberately charging in times of low power prices or high availability of renewable energies.

The remote control of the charging functions of a vehicle is not only a software-side process in this case, but also influences physical components in the vehicle itself. A central safety-relevant component in this case is the so-called charging contactor, a mechanical high-voltage switch, which electrically disconnects the battery from the remaining high-voltage system of the vehicle. The contactor opens, for example, after ending of a charge procedure or during a charging pause in order to avoid potential hazards due to high voltage. Such contactors are only designed for a limited number of mechanical operations, so-called switching cycles, over the lifetime. Each switching cycle corresponds here to opening and subsequent closing of the contact. The number of these cycles therefore has to be technically and economically limited in order to avoid premature wear.

The control of the charging behavior by third parties by the remote charging API therefore has a direct influence on the lifetime of the charging contactors installed in the vehicle. A frequent change between charging states, in particular due to deliberate interruptions and resumptions of the charging procedure, can increase the number of the switching cycles. Previous solutions have been based on access counts on the API level in the form of quota systems within sliding time windows in order to prevent excess strain of the contactors. These methods do not directly detect whether an API call has actually resulted in a switching procedure, however. Rather, cases exist in which mechanical opening or closing of the contactor is not required due to changes of the charging settings. Moreover, it is not always ensured that a command initiated by the B2B partner is actually received and executed by the vehicle, for example due to a lack of Internet connection. There is also presently no option in the backend itself to determine with sufficient reliability whether a specific command has triggered a switching cycle, since switching cycle counters or corresponding feedback mechanisms are not present in the existing fleet.

For reliable and lasting usage of such remote charging functionalities, it is therefore necessary to be able to determine even under the given technical restrictions in the backend whether a triggered command has resulted in a switching cycle. This is crucial in particular for the integration of existing vehicles into network-beneficial charging strategies, without excessively straining the physical infrastructure of the vehicles or intervening in safety-relevant operating areas in this case.

An object of the present disclosure is to provide a method improved in this regard, in particular one which can determine in spite of the mentioned circumstances in the backend whether a command triggers a switching cycle.

This object is achieved by the subject matter of the present disclosure. Advantageous configurations are also disclosed herein.

The present disclosure relates to a method for determining whether a charging mode setting for a vehicle received by an external control interface (API) triggers an additional switching cycle of a charging contactor comprised in the vehicle, the method comprising the following steps: receiving a charging mode setting via the external control interface, providing vehicle-specific charging parameters, detecting a current state of charge of the vehicle with regard to multiple operating modes, simulating a state of charge after executing the received charging mode setting on the basis of the provided vehicle-specific charging parameters, comparing the current and simulated state of the vehicle to determine whether a transition between the multiple operating modes exists, which causes a new additional switching cycle of the charging contactor, and determining the received charging mode setting as an additional switching cycle only in the case of such a transition.

The present disclosure also comprises a system for determining additional switching cycles of a charging contactor installed in a vehicle, comprising: a vehicle having a charging contactor, a vehicle-side backend for providing vehicle-specific charging parameters, an external control interface (API) for communication of charging mode settings by external partners, a control backend designed to receive charging mode settings, detect the current state of charge of the vehicle, simulate the state of charge after executing the charging mode setting, and determine, based on the comparison of the current and simulated state, whether an additional switching cycle is caused.

The reception of a charging mode setting via the external control interface preferably relates to the input of a control command from an external system via an external control interface or a defined programming interface (API). Preferably, this is a communication interface which enables third-party providers to transmit charging commands such as "immediate charging" or "time window charging" to the backend of a vehicle producer.

The provision of vehicle-specific charging parameters preferably comprises retrieving and storing information such as the current state of charge, a target state of charge, the connection to a charging station, and possibly a planned departure time. These data preferably originate from the backend of the vehicle or from a fleet system and are in particular kept up-to-date.

The detection of a current state of charge of the vehicle with regard to multiple operating modes preferably means that an interpretation of the system state is carried out on the basis of combined parameters such as charging mode, charging time window, and actual charging procedure. The "multiple operating modes" preferably designate states differentiable on the system side such as active immediate charging, active time window charging, and inactive time window charging. The advantage is that state changes can be associated with potential physical switching procedures.

The simulation of a state of charge after execution of the received charging mode setting preferably comprises a hypothetical assessment of the effect of a command triggered by the charging mode setting on the charging behavior. Preferably, an expected future operating state is calculated using the current parameters. It is technically advantageous here that the charging behavior can be anticipated without an actual intervention in the vehicle behavior being necessary.

Upon the comparison of the current and the stimulated state of the vehicle, it is preferably determined whether a transition between the defined operating modes occurs due to the intended charging mode change.

The determination of the received charging mode setting as an additional switching cycle preferably only takes place in case of a transition triggering a switching cycle. Preferably, a count of the switching procedure is thus only initiated when a change takes place into a state which makes physically opening and closing a charging contactor necessary. The term "switching cycle" preferably designates a complete mechanical opening and closing procedure of a charging contactor which functions as a safety device between battery and high-voltage system. The advantage is the option of limiting wear on mechanical components due to external control commands in a controlled manner.

The charging mode setting designates a setting transmitted via an external control interface to a vehicle or its backend for controlling the charging behavior of the vehicle. Such a setting can comprise, for example, the mode "immediate charging", in which the vehicle begins immediately with the charging, or a "time window mode", in which the charging only takes place within a defined time interval. The charging mode setting can optionally also include parameters such as charging time window or target states of charge.

Vehicle-specific charging parameters comprise technical and state-dependent information of a vehicle which can be used to assess the current or simulated charging behavior. This includes in particular the state of charge (SOC), the target state of charge (target SOC), the connection status to a charging station, and possibly a configured departure time.

The term switching cycle designates a mechanical operation of a charging contactor installed in the vehicle, during which this passes once from a closed to an open state and subsequently back to the closed state or vice versa. Switching cycles typically occur at the beginning of charging or end of charging, in particular upon the change between states of charge.

An additional switching cycle is present when a change of the charging behavior of the vehicle triggered by a charging mode setting newly causes such a mechanical opening and closing procedure of the charging contactor, which would not have occurred without the charging mode change.

External control interface designates a programming interface (API) assigned to the vehicle producer, via which authorized external partners, in particular energy suppliers or fleet operators, can set vehicle charging settings for individual vehicles or vehicle groups.

The term vehicle comprises any system for conveying people and goods on roads, e.g. passenger vehicle, truck, bus, caravan, motorcycle, on rails, on the water, or in the air. The vehicle can be driven by a combustion drive, a hybrid drive, or a purely electric drive. Public or private charging stations can use the method. Any battery usable for an electric or hybrid drive, such as a lithium-ion battery, also called a lithium-ion accumulator or lithium accumulator, can be used. The terms "battery" and "accumulator" correspond.

In a further aspect, it is proposed that the vehicle-specific charging parameters comprise a state of charge, a target state of charge, a connection status to a charging station, and/or a configured departure time of the vehicle.

The vehicle-specific charging parameters preferably comprise a state of charge, which indicates the current energy content of the vehicle battery relative to the total capacity. The state of charge (SOC) is preferably specified in percent and is used as a central variable for determining the current energy requirement. A further parameter is preferably the target state of charge (target SOC), which defines the state of charge to which the vehicle is to be charged, wherein this value is configurable on the driver side or system side. This enables charging planning suitable for needs. The connection status to a charging station preferably indicates whether the vehicle is physically connected to charging infrastructure, which is a requirement for every charging procedure. This information is technically advantageous since it supplies the context for the assessment of charging commands and reduces the occurrence of non-executable commands. Furthermore, the configured departure time preferably designates the time at which the user plans to put the vehicle back into operation. This time specification permits an optimization of the charging times with regard to network load and power prices and therefore improves the energy efficiency and user-friendliness.

In a further aspect, it is proposed that charging mode settings are ignored if the vehicle is not connected to a charging station and/or the state of charge at least corresponds to the target state of charge.

Charging mode settings are preferably ignored if the vehicle is not connected to a charging station, since under these circumstances a charging procedure would not be technically executable. The connection status preferably reflects the physical contact between vehicle and charging point and is therefore decisive for the effectiveness of a charging mode command. A further case for the ignoring is preferably provided when the current state of charge at least corresponds to the target state of charge, since in this case there is no immediate charging requirement. This condition prevents unnecessary control commands which would not have an effect and contributes to preserving system resources and mechanical components such as the charging contactor. The state of charge and target state of charge are preferably used here as logical comparative variables for assessing the necessity for a charging procedure.

In a further aspect, it is proposed that the multiple operating modes comprise at least the following states: charging in a mode "immediate charging", in which the vehicle is currently being charged, charging in a mode "time window charging" within an active charging time window, in which the vehicle is presently being charged, and not charging in a mode "future time window" having a charging time window lying in the future, in which the vehicle is currently not yet being charged.

The multiple operating modes preferably comprise three central states: In the mode "immediate charging", the vehicle is presently being charged, in particular independently of time specifications. This mode enables a direct energy supply and is preferably useful in the case of short-term energy requirement. The mode "time window charging" within an active charging time window preferably describes a time -controlled charging activity in which the vehicle only charges within a configured time interval. This operating mode is preferably suitable for network-beneficial load shifting. In the mode "future time window", the set charging interval lies in the future, and the vehicle is presently not charging. This state is preferably characterized by charging procedures which are planned but have not yet begun. The option of planning control commands beforehand without triggering immediate system interventions is technically advantageous here. The distinction of these three operating modes permits a precise assessment of whether a transition takes place due to a charging mode change which makes a mechanical switching procedure necessary.

In a further aspect, it is proposed that an additional switching cycle is only determined if a transition is present from the mode "immediate charging" or from the active mode "time window" into a mode "future time window" with beginning of charging in the future.

An additional switching cycle is preferably only determined if a transition takes place from an active charging mode, such as "immediate charging" or "time window" within an active window, into a passive mode with a future charging time window. In this case, the vehicle initially ends the active charging procedure and preferably opens the charging contactor, by which a mechanical switching procedure is triggered. Only transitions actually relevant to the switching cycle are thus counted. The term "switching cycle" preferably designates a complete mechanical procedure of opening and subsequently closing an electrical high-voltage contactor, which is connected between battery and charging infrastructure for safety reasons. The selective consideration of transitions reduces unnecessary counts and improves the prediction accuracy for the lifetime of the charging contactor.

In a further aspect, it is proposed that the simulation of the state of charge comprises an anticipation of a charging decision of the vehicle after application and/or adoption of the charging mode setting.

The simulation of the state of charge preferably comprises the software-controlled anticipation of a charging decision which the vehicle would make after application and/or adoption of a transmitted charging mode setting. It is preferably calculated in this case with assumption of valid charging parameters whether and when the vehicle is expected to begin with a charging procedure or would end it. The advantage is that the system can assess early whether a control instruction would result in a physically relevant event, in particular a switching cycle. The term "simulation" preferably designates a method for modeling future system behavior on the basis of available input variables without a real action having to be triggered on the vehicle.

In a further aspect, it is proposed that exclusively charging mode settings are counted for which a transition triggering a switching cycle was identified by the simulation.

Exclusively those charging mode settings are preferably counted in the case of which a transition was established by the above-mentioned simulation, which is linked with an additional switching cycle of the charging contactor. This selective detection preferably permits the determination of switching-relevant control events to be focused on real operational relationships and avoids excessive counting of technically irrelevant commands. This enables a more precise and wear-oriented assessment of the actual mechanical strain. The term "transition triggering a switching cycle" preferably designates a system state change, during which the opening and/or closing of a high-voltage contactor is actually necessary.

In a further aspect, it is proposed that the method is used for controlled limiting of the switching cycles caused by external control commands.

The method is preferably used to deliberately monitor and limit the number of the switching cycles caused by external control commands. It is preferably thus ensured that mechanical components such as the charging contactor are not overstrained by frequent load changes. Increasing the lifetime of safety-critical hardware while simultaneously retaining the functionality of external charging interfaces is advantageous.

In a further aspect, it is proposed that the decision about the presence of a transition triggering a switching cycle is documented in a charging event database.

The decision of whether a transmitted control command has caused a transition triggering a switching cycle is preferably documented in a charging event database. This database preferably contains structured entries which capture the time, type of the control command, vehicle identifier, and the simulation result. The advantage is the seamless traceability of charging events and the option of carrying out analyses on the system strain or for regulatory purposes.

In a further aspect, it is proposed that a vehicle identifier is assigned to each counted switching cycle, and a cumulative count is managed specifically by vehicle.

A unique vehicle identifier is preferably assigned to each counted switching cycle in order to be able to track the switching load specifically by vehicle. This vehicle identifier can preferably be a VIN (vehicle identification number) or an internal ID. The data thus captured are preferably aggregated in one cumulative counter per vehicle. This opens up the possibility of precisely monitoring the lifetime limits of individual vehicles and possibly deriving vehicle-specific measures.

In a further aspect, it is proposed that if a predefined switching cycle limit is exceeded for a vehicle, a notification to an operator of the charging planning takes place.

If a predefined switching cycle limit for a vehicle is exceeded, a notification preferably takes place automatically to a charging planning responsible party or a backend operator. This notification preferably takes place electronically via a monitoring or messaging system.

In a further aspect, it is proposed that the charging cycle detection is used for invoicing an API usage with respect to an external partner.

The detection of charging cycles is preferably also used to invoice the API usage with respect to an external partner. In this case, exclusively control commands triggering a switching cycle are preferably used as the foundation for invoicing, which enables a wear-oriented compensation for external interventions. The term "API usage" preferably designates the sum of the valid external control commands which are input via a defined interface and executed in the backend.

The present disclosure also comprises a computer program product, comprising commands which, when the method is executed by a computer, cause the computer to carry out the method.

The present disclosure also comprises a computer-readable medium on which the computer program product is stored.

Exemplary embodiments of the present disclosure are illustrated in the figures and are described in more detail below. Hereinafter, unless indicated otherwise, the same reference signs are used for identical and functionally identical elements.

Other objects, advantages and novel features of the present disclosure will become apparent from the following detailed description of one or more preferred embodiments when considered in conjunction with the accompanying drawings.

### BRIEF DESCRIPTION OF THE DRAWINGS

FIG. 1 shows a schematic flow chart of an exemplary embodiment of the method,

FIG. 2 shows a schematic block diagram of an exemplary embodiment of the system,

FIG. 3 shows a schematic flow chart of an exemplary charging sequence plan, and

FIG. 4 shows a schematic representation of changes between various operating modes.

### DETAILED DESCRIPTION OF THE DRAWINGS

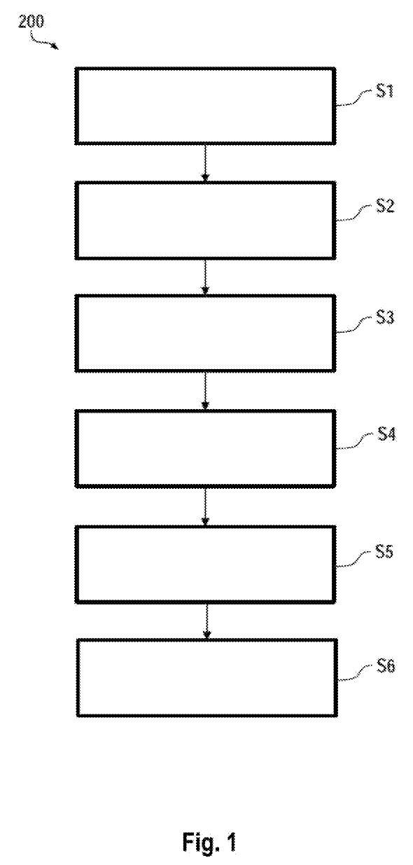

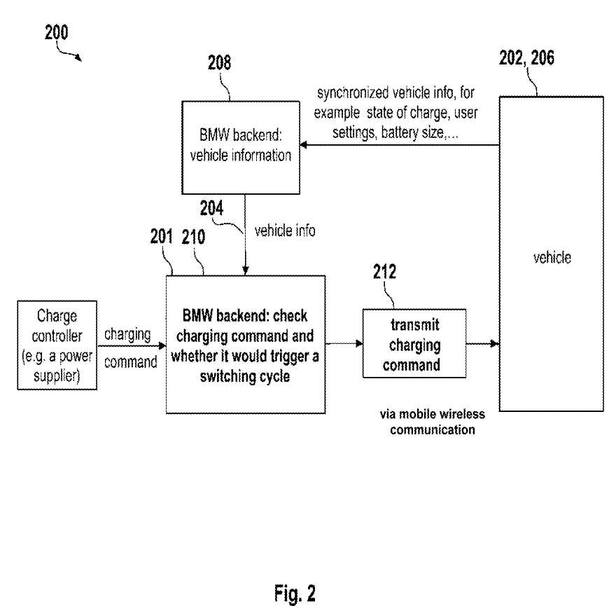

FIG. 1 shows the method according to the present disclosure in a first embodiment on the basis of a schematic flow chart. The method will also be explained with reference to FIG. 2, which shows a schematic block diagram of a system 200 according to the present disclosure in one embodiment. The method is used to determine whether a charging mode setting for a vehicle 202 received by an external control interface (API) 201 triggers an additional switching cycle of a charging contactor comprised in the vehicle 202.

In a first step S1, a charging mode setting is received via the external control interface 201. In a first step S2, vehicle-specific charging parameters 204 are provided. In a first step S3, a current state of charge of the vehicle 202 is detected with regard to multiple operating modes. In a first step S4, a state of charge after execution of the received charge mode setting on the basis of the provided vehicle-specific charging parameters 204 is simulated. In a first step S5, the current and the simulated state of the vehicle 202 are compared to determine whether a transition between the multiple operating modes exists, which causes a new additional switching cycle of the charging contactor, and, only in the case of such a transition, in a step S6, the received charging mode setting is determined as an additional switching cycle.

The system 200 shown in FIG. 2, which is designed to determine additional switching cycles of a charging contactor 206 installed in the vehicle 202, comprises the vehicle 202 having a charging contactor 206. Furthermore, the system 200 comprises a vehicle-side backend 208 for providing the vehicle-specific charging parameters 204 as well as the external control interface (API) 206 for the communication of charging mode settings by external partners. Furthermore, the system 200 also comprises a control backend 210 designed to receive charging mode settings, detect the current state of charge of the vehicle, simulate the state of charge after execution of the charging mode setting, and determine, based on the comparison of the current and the simulated state, whether an additional switching cycle is caused. A charging modulation 212 preferably takes place via mobile wireless communication with the vehicle 202.

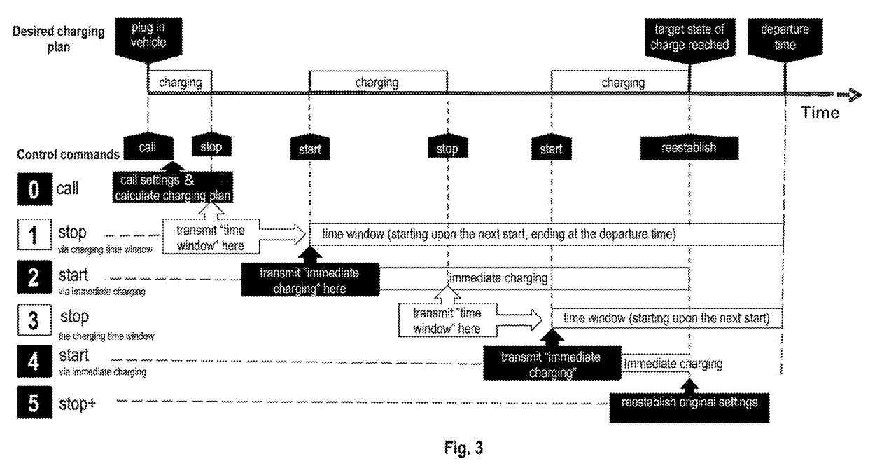

FIG. 3 shows a flow chart to illustrate an exemplary limitation of a charging plan-based control method for a vehicle using an external programming interface (API). It is shown here how the vehicle 202, after the connection to the charging station (vehicle plug-in), carries out a charging procedure consisting of multiple control commands or charging commands. The charging procedure takes place until the target state of charge is reached (target SOC) or until a departure time is reached (departure time). A total of five different control commands (commands) are indicated, which are carried out offset in time in relation to one another.

The horizontal axis represents the progress of time, beginning with the plugging in (vehicle plug-in) and ending with the planned departure time (departure time). The desired charging plan ("desired plan") is shown along this time axis, wherein charging phases are symbolized by continuous bars.

Control commands ("commands") numbered from 0 to 5 are shown in the lower area of FIG. 3. Each of these commands is connected to a specific function, for example for stopping or starting the charging procedure by setting specific charging modes. The command 0 ("get") is used for the retrieval of vehicle-specific charging parameters and for the initial calculation of the charging plan. Commands 1 and 3 ("stop via charging window") each set a charging time window for interrupting the charging procedure. Commands 2 and 4 ("start via immediate charge") activate immediate charging by changing to the mode "immediate charging". The command 5 ("stop+") is used to reset the charging settings to prior values.

FIG. 3 furthermore shows the times at which the individual commands are to be carried out to implement the desired charging course. This comprises in particular repeated transitions between the modes "time window" and "immediate charging", depending on the SOC (state of charge) and the planned departure time. The incorporation of a new charging time window takes place in each case upon charging interruption, while a command for immediate charging is transmitted upon charging beginning. This ensures that the target state of charge (target SOC) is reached at the planned time. At the end of the charging plan, the original settings are reestablished by a "restore" command.

The sequence shown illustrates how external partners can implement dynamic charging behavior having multiple charging and pause phases via defined API commands, without triggering unnecessary switching cycles in the vehicle in this case. The combination of time window control and immediate charging is used to create a network-beneficial, cost-optimized, and vehicle-integrated charging profile.

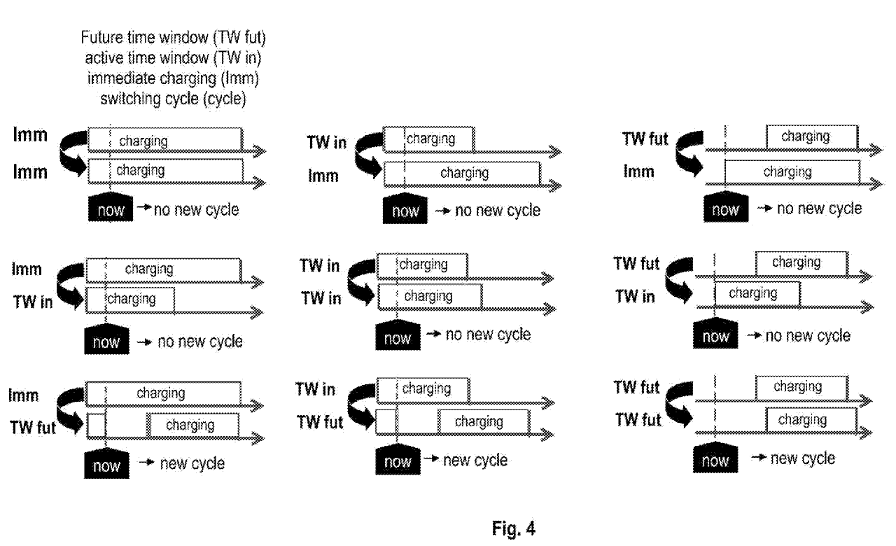

FIG. 4 shows that the multiple operating modes comprise at least the following states, namely charging in a mode "immediate charging" (abbreviated as "Imm" in FIG. 4), in which the vehicle 202 is currently being charged; charging in a mode "time window charging" (abbreviated as "TW-in" in FIG. 4) within an active charging time window in which the vehicle 202 is presently being charged; and not charging in a mode "future time window" (abbreviated as "TW fut" in FIG. 4) with a charging time window lying in the future, in which the vehicle 202 is currently not yet being charged. The nine possible changes between the operating modes shown in FIG. 4 result due to the three different operating modes. An additional switching cycle is only determined as such when a transition is present from the mode "immediate charging" (abbreviated as "Imm" in FIG. 4) or from the active mode "time window" (abbreviated as "TW-in" in FIG. 4) to a mode "future time window" (abbreviated as "TW-fut" in FIG. 4) with charging beginning in the future.

The features of the present disclosure described with reference to the illustrated embodiments can also be present in other embodiments of the present disclosure, unless indicated otherwise or prohibited for technical reasons.

The foregoing disclosure has been set forth merely to illustrate the present disclosure and is not intended to be limiting. Since modifications of the disclosed embodiments incorporating the spirit and substance of the present disclosure may occur to persons skilled in the art, the present disclosure should be construed to include everything within the scope of the appended claims and equivalents thereof.

### LIST OF REFERENCE SIGNS

200 system
201 external control interface
202 vehicle
204 vehicle-specific charging parameters
206 charging contactor
208 vehicle-side backend
210 control backend
212 charging modulation
S1 method step
S2 method step
S3 method step
S4 method step
S5 method step
S6 method step

What is claimed is:

1. A method for determining whether a charging mode setting for a vehicle received by an external control interface triggers an additional switching cycle of a charging contactor of the vehicle, the method comprising:
receiving a charging mode setting via the external control interface;
providing vehicle-specific charging parameters;
detecting a current state of charge of the vehicle with regard to multiple operating modes;
simulating a state of charge after execution of the received charging mode setting on a basis of the provided vehicle-specific charging parameters;
comparing the current state of charge and the simulated state of charge of the vehicle to determine whether a transition exists between the multiple operating modes which causes a new additional switching cycle of the charging contactor; and
in response to such a transition, determining the received charging mode setting as an additional switching cycle.

2. The method according to claim 1,
wherein the vehicle-specific charging parameters comprise the state of charge, a target state of charge, a connection status to a charging station, and/or a configured departure time of the vehicle, and
wherein charging mode settings are ignored in response to the vehicle not being connected to a charging station and/or the state of charge at least corresponds to the target state of charge.

3. The method according to claim 1,
wherein the multiple operating modes comprise at least the following states:
charging in an "immediate charging" mode in which the vehicle is currently being charged,
charging in a "time window charging" mode within an active charging time window, in which the vehicle is presently being charged, and
not charging in a "future time window" mode with a charging time window lying in the future, in which the vehicle is currently not yet being charged.

4. The method according to claim 3,
wherein an additional switching cycle is determined in response to a transition being present from the "immediate charging" mode or from the active "time window" mode into a "future time window" mode with beginning of charging in the future.

5. The method according to claim 1,
wherein the simulation of the state of charge comprises an anticipation of a charging decision of the vehicle after application and/or adoption of the charging mode setting.

6. The method according to claim 1,
wherein exclusively charging mode settings are counted for which a transition triggering a switching cycle was identified by the simulation.

7. The method according to claim 1, comprising:
controlled limiting of the switching cycles caused by external control commands.

8. The method according to claim 1,
wherein a decision about a presence of a transition triggering a switching cycle is documented in a charging event database.

9. The method according to claim 1,
wherein a vehicle identifier is assigned to each counted switching cycle, and a cumulative count is managed specifically by vehicle.

10. The method according to claim 1,
wherein in response to a predefined switching cycle limit being exceeded for a vehicle, a notification takes place to an operator of the charging planning.

11. The method according to claim 1,
wherein a charging cycle detection is used to invoice an external control interface usage with respect to an external partner.

12. A system for determining additional switching cycles of a charging contactor of a vehicle, the system comprising:
a vehicle having a charging contactor;
a vehicle-side backend configured to provide vehicle-specific charging parameters;
an external control interface configured to communicate charging mode settings by external partners; and
a control backend configured to receive charging mode settings, detect a current state of charge of the vehicle, simulate the state of charge after execution of the charging mode setting, and determine, based on a comparison of the current and the simulated state, whether an additional switching cycle is caused.

13. A non-transitory computer-readable medium having stored thereon a computer program product that, when executed by a computing device, cause the computing device to execute a method for determining whether a charging mode setting for a vehicle received by an external control interface triggers an additional switching cycle of a charging contactor of the vehicle, the method comprising:
receiving a charging mode setting via the external control interface;
providing vehicle-specific charging parameters;
detecting a current state of charge of the vehicle with regard to multiple operating modes;
simulating a state of charge after execution of the received charging mode setting on a basis of the provided vehicle-specific charging parameters;
comparing the current state of charge and the simulated state of charge of the vehicle to determine whether a transition exists between the multiple operating modes which causes a new additional switching cycle of the charging contactor; and
in response to such a transition, determining the received charging mode setting as an additional switching cycle.
